(19) United States
(12) Patent Application Publication
(10) Pub. No.: US 2005/0246254 A1
(43) Pub. Date: Nov. 3, 2005

(54) Method of establishing a futures market for polution

(76) Inventor: Anders Hoglund, Vejbystrand (SE)

Correspondence Address: FASTH LAW OFFICES (ROLF FASTH), 26 PINECREST PLAZA, SUITE 2, SOUTHERN PINES, NC, 28387-4301, US

(21) Appl. No.: 10/526,835

(22) PCT Filed: Aug. 29, 2003
(86) PCT No.: PCT/US03/27357

§ 371 Date: Mar. 5, 2005

(30) Foreign Application Priority Data
Sep. 6, 2002 (US) 60319526

(51) Int. Cl. G06F 17/60

(52) U.S. Cl. 705/35

(57) ABSTRACT

The method of reducing pollution of a pollutant by relying on the market forces to set the pollution fees charged for pollution. The marginal cost (m1) is known by actors, companies, individuals or actors for reducing one pollution unit of the pollutant. The current market rate of futures cost/price (n1) for a pollution unit is then determined by the market. The pollution fee (s1) is set by legislation to be the same as the futures cost/price to ensure genuine uncertainty (n1). The polluter then compares the marginal cost with the futures cost/price. If the marginal cost is less than the futures cost/price, the polluter may invest in pollution reducing equipment and sell futures at the current market price.

### FIELD OF INVENTION

The method of the present invention is for establishing a futures market for pollution fees.

### BACKGROUND OF INVENTION

The pollution fees charged by governments are determined in a somewhat arbitrary way. It is important to set the pollution fees or taxes in a way that correctly balances the various economic and environmental forces in a modern society. In general, it is ineffective to charge companies too much because, among other things, that may result in capital destruction, misdirected and inefficient use of resources and a slowdown in economic growth since most taxes and fees are passed on to the consumers. It is also ineffective not to charge enough because that may promote excessive pollution, destruction of natural resources and environment and a lowering of companies' willingness to invest in pollution reducing equipment and technology. Governments have been struggling with the task of how to set the correct fee without much success since the pollution fees must change in time as the economic conditions and pollution situation change. Efforts have been made to set a fixed amount of total pollution that is acceptable to society. Companies are then allocated shares or permitted pollution quantities so that a company may pollute up to the allowable pollution quantity limit without being penalized. The allocated companies may then trade the pollution quantities or the permission to pollute. One drawback is that the artificially and politically biased fixed total amount of pollution and the company allocations may be incorrect. This downstream type of taxation is cumbersome because it requires the measurement of the actual pollution quantities for each company. It may also be complicated to develop a fair sanction or penalty system when a company has exceeded its allowable pollution quantity. There is a need for an effective and reliable way of setting the correct pollution fees that does not promote excessive pollution or hinder economic growth.

### SUMMARY OF INVENTION

The present invention provides a solution to the above outlined problems. More particularly, the present invention is a method of reducing the emitted quantity of a pollutant by relying on the market forces to set the pollution fees charged for pollution. The marginal for reducing the emissions by one unit of the pollutant cost is known by companies, individuals or actors. The current market price of futures for a pollution unit is then determined. The pollution fee is regularly set by law or decree to be the same as the current price of futures to ensure genuine uncertainty. The polluter then compares the marginal cost with the futures price. If the marginal cost is less than the futures cost, the polluter is free to invest in pollution reducing equipment and to sell futures at the current market price. At the end of the contract term, or earlier if needed, the polluter may buy back the futures. On the other hand, if the marginal cost is higher than the future cost, the polluter is equally free to buy futures at the current market price. At the end of the contract term the polluter, accordingly, is free to sell back the futures. The total cost for the pollution fees paid and the futures trading can show a loss or a profit. The company that invested in pollution reducing equipment makes a profit from the futures trading when the futures cost is reduced, which encourages such investments.

### BRIEF DESCRIPTION OF DRAWING

FIG. 1 is a schematic flow diagram of the method of the present invention.

### DETAILED DESCRIPTION

The present invention is a method of using a primary market to determine pollution fees for the purpose of internalizing the cost of pollution reductions in the economy. The method includes using a primary market to reduce the risk for companies or individuals in varying pollution-reduction-costs under environmental restraints. The method is using a primary market to ensure efficiency of pollution reductions in space and time. The method is for repayment of pollution fees to ensure political acceptance for market driven solutions of environmental problems.

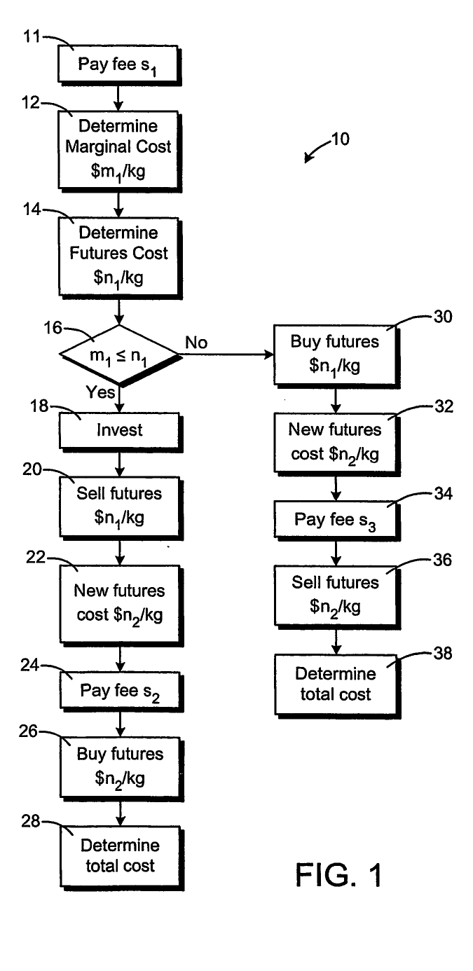

With reference to FIG. 1, the method 10 of the present invention is a system that permits fees such as a pollution fee paid, directly or indirectly, to the government/authorities or an environment fund. The market forces determine the pollution fee in a way similar to the way the price of a futures contract for commodities is determined, although no commodity is involved in this case. An important feature of the method of the present invention is that the pollution fee varies with the supply and demand of the market forces.

The method 10 includes the step 11 of paying a pollution fee (s1) for the time period (t1) by using company A's current equipment. The time period (t1) may be equivalent to a consumption that produces (x1) kg pollution. The fee may be an upstream payment or a downstream payment. The upstream payment (s1) may be a tax on fuel or chemicals that is added to the price of the fuel/chemicals so that the fee is an indirect cost for company A. The downstream payment may be a payment that is-based on the direct pollution. The method also includes the step of determining 12 company A's marginal cost (MC) for reducing pollution, such as the emission carbon dioxide. Company A's actual marginal cost partly depends on the age and condition of company A's equipment. The marginal cost may be the cost or investment required to decrease the emissions with one kilogram (kg). The marginal cost for company A may be $m1/kg where the parameter m1 may be any monetary value.

In a second step 14, company A determines the futures contract cost regarding the particular pollutant in question for the particular industry. For example, the current futures market rate may be $n1/kg such as $1.00/kg. The parameter (n1) may be the average alternative cost for avoiding pollution for all companies in the particular industry of company A.

In general, the companies may use the futures market for pollution fees to ensure there is some guaranteed return from investments for pollution reducing technologies. For example, if a new technology is developed that dramatically lowers the cost of reducing pollution and company A has already invested in the higher cost technology, company A may benefit from the investment by selling futures at the current market price and buying back at a lower market price at the end of the contract term, as explained in detail below.

As indicated above, futures are commonly traded for commodities wherein the commodity is traded at a certain price and the futures market is normally traded at a different price. The current method 10 does not involve any commodities but a pollution fee and the size of the fee itself and the price of the futures costs are identical since there is no underlying commodity.

In a comparison step 16, the company determines if the company's marginal cost $m1/kg is less than the futures cost $n1/kg. If the marginal cost (m1) is less than the futures cost (n1), then it is advantageous for company A to invest in pollution reducing equipment, as shown in the investment step 18, that reduces the current pollution from (x1) kg/time period to (x2) kg/time period. In a selling step 20, it is advantageous for company A to sell (x1-x2) kg of futures at the current market price of $n1/kg. As shown in step 22, the futures cost may change from $n1/kg to $n2/kg.

If the fuel paid for in step 11 is consumed at the end of time period (t1), company A pays an indirect consumption fee (s2), as shown in the pay step 24, that is based on the newly reduced consumption of (x2) kg for time period (t2) since the investment in step 18 reduced the consumption from (x1) kg per time period or unit to (x2) kg per time period or unit. As indicated above, the fee (s2) may be charged indirectly in the form of a tax that is added to the price of fuel or chemicals in question. Of course, the fee (s2) may also be a direct fee, based on actual pollution amounts.

At the expiration of the contract term, company A buys back the futures sold in step 20 at $n2/kg, as shown in buy step 26, in view of the market change in step 22. In the determination step 26, company A's total cost (T1) is (s1)+(s2)+(x1−x2) (n2−n1) where the parameter (x2) is smaller than the parameter (x1). The fee (s1) may be calculated as $x1*n1 and the fee (s2) may be calculated as $x2*n2. If the market price $n2/kg is lower than the old market price $n1/kg, company A has made a profit from the futures trading and the futures trading reduces the overall cost. In this way, the futures trading may be seen as insurance in view of the extra investments made to reduce the pollution amounts.

If the futures cost $n1/kg is greater than the marginal cost $m1/kg in step 16 then company A buys futures at the current market price $n1/kg, as shown in buy step 30. The amount of futures is equivalent to x1 kg, that is the current pollution per time contract period. In general, this can be seen as a way for the company to buy time. The market may then change the futures cost from $n1/kg to $n2/kg, as shown in step 32.

If the fuel paid for in step 11 is fully consumed at the end of time period (t1) then company A pays a fee (s3), as shown in the pay step 34, that is equivalent to the same pollution or fuel consumption of x1 kg since no investment was made to reduce the pollution and thus the fuel consumption so the fee (s3) may be calculated as $n2*x1 kg for the next contract period.

At the expiration of the contract term, company A sells back the futures, bought in step 30, at the new current market price of $n2/kg, as shown in sell step 36. In the determination step 28, company A's total cost (T2) is (s1)+(s3)+x1*(n2−n1). The fee (s1) may be calculated as $x1*n1 and the fee (s3) may be calculated as $x1*n2. If the market price (n2) is lower than the market price (n1), company A has lost on the futures trading also and the total cost (T2) could be substantially higher than total cost (T1) had the company invested in pollution reducing technology. The option of buying futures is not cost effective if the overall average future cost, thus the average marginal cost for all the companies in the industry, is reduced. This may encourage investments in pollution reducing equipment and thus the market forces reduce the amount of pollution.

It may be possible to return the pollution fees collected by the government, such as the fees (s1), (s2) and (s3), to each individual citizen. This manner of return payment ensures that a majority of people will always benefit from the method 10, making it politically easier to introduce the method.

While the present invention has been described in accordance with preferred compositions and embodiments, it is to be understood that certain substitutions and alterations may be made thereto without departing from the spirit and scope of the following claims.

1. A method of reducing pollution of a pollutant, comprising:
determining a marginal cost (m1) for reducing one pollution unit of the pollutant;
determining a futures cost (n1) for one pollution unit of the pollutant;
setting a pollution fee (s1) to be the same as the futures cost (n1) of the pollutant;
in a comparison unit, comparing the marginal cost (m1) with the futures cost (n1);
when the marginal cost (m1) is less than or the same as the futures cost (n1), invest in pollution reducing equipment to reduce pollution from a first quantity (x1) to a second quantity (x2), the difference between the first quantity (x1) and the second quantity (x2) being a delta quantity (d);
selling the delta quantity (d) of futures at futures cost (n1);
changing futures cost from (n1) to (n2);
at a termination of futures contract term, buying back delta quantity (d) of futures at futures cost (n2); and
determining a total cost (T1) by adding the pollution fee (s1) and the delta quantity (d) multiplied by a difference between futures cost (n2) and futures cost (n1).

2. The method according to claim 1 wherein the method further comprises paying a pollution fee (s1) at a beginning of time period (t1).

3. The method according to claim 2 wherein the method further comprises paying a pollution fee (s2) at a beginning of time period (t2).

4. The method according to claim 1 wherein the method further comprises buying futures equivalent to the first pollution quantity (x1) at the futures cost (n1) when the marginal cost (m1) is greater than the futures cost (n1).

5. The method according to claim 4 wherein the method further comprises calculating a fee (s3) as the futures cost (n2) multiplied by the first quantity (x1) and paying the fee (s3) at the end of time period (t2).

6. The method according to claim 5 wherein the method further comprises selling the first quantity (x1) of futures at the futures cost (n2).

7. The method according to claim 6 wherein the method further comprises determining a total cost (T2) by adding the fee (s1) and the fee (s3) and the quantity (x1) multiplied by the difference between the futures cost (n2) and the futures cost (n1).
